(19) United States
(12) Patent Application Publication
(10) Pub. No.: US 2007/0101976 A1
(43) Pub. Date: May 10, 2007

(54) Method for manufacturing an ignition coil and corresponding ignition coil

(76) Inventors: Reinhard Seidl, Sonthofen (DE); Lothar Detels, Burgberg (DE); Klaus Lerchenmueller, Immenstadt (DE); Konstantin Lindenthal, Blaichach (DE); Nikolaus Hautmann, Ditzingen (DE); Markus Knepper, Waltenhofen/Oberdorf (DE); Karl-Heinz Mader, Kempten (DE); Florian Herzog, Waltenhofen (DE)

Correspondence Address: KENYON & KENYON LLP, ONE BROADWAY, NEW YORK, NY, 10004, US

(21) Appl. No.: 11/584,090

(22) Filed: Oct. 20, 2006

(30) Foreign Application Priority Data
Oct. 20, 2005 (DE) 10 2005 050 270.9

(51) Int. Cl. H01F 38/12; F02P 3/02; G11B 5/127; H04R 31/00

(52) U.S. Cl. 123/634; 123/635; 29/603.06; 29/603.24

(57) ABSTRACT

An ignition coil has an ignition coil housing having a core and coil forms situated within it. In order to fill in the gaps between the components in the ignition coil housing using a cast resin used as insulation, the invention provides to introduce the latter either by a hollow needle or a riser directly into the bottom region of the ignition coil housing. The method described herein allows for a homogeneous material distribution of the cast resin and avoids inclusions of foreign particles or gases in the ignition coil housing.

### FIELD OF THE INVENTION

The present invention relates to a method for manufacturing an ignition coil, in particular a rod-type ignition coil.

### BACKGROUND INFORMATION

European Patent No. 862 807 shows an ignition coil in the form of a rod-type ignition coil has a channel running in the longitudinal axis of its core or parallel with respect to it, which extends into the bottom region of the ignition coil housing below the secondary and primary winding. Via a casting nozzle, the initially liquid insulating resin is introduced into the channel from above, i.e. from the side of the ignition coil housing lying opposite from the bottom region, from where it runs down the channel on account of gravity and subsequently fills in the ignition coil housing starting from the bottom region in the form of a so-called rising cast.

The known method requires a specially configured ignition coil, which has a channel for introducing the insulating resin into the bottom region that increases the space requirement of the ignition coil. Furthermore, additional structural measures such as separating chambers or the like are possibly required, which prevent the insulating resin from entering, for example, electrical connection regions of the ignition coil in the upper region of the ignition coil housing. In this respect, the end of the casting process, in which the casting nozzle is removed from the lid area of the ignition coil housing, also represents a critical process step since casting resin should be prevented from dripping off from the casting nozzle.

### SUMMARY OF THE INVENTION

By contrast, the method according to the present invention for manufacturing an ignition coil has the advantage that the ignition coil does not require any channel or the like that would increase the space requirement, in particular the diameter.

Advantageous further developments of the method according to the present invention as well as suitable ignition coils for implementing the method are indicated in the dependent claims.

It is particularly advantageous to introduce the insulating resin into the bottom region of the ignition coil or the ignition coil housing with the aid of a feed device in the form of a hollow needle.

### BRIEF DESCRIPTION OF THE DRAWINGS

FIG. 1 shows a longitudinal cross section through an ignition coil in which the ignition coil housing is filled with an insulating resin laterally in the bottom region with the aid of a hollow needle.

FIGS. 2 and 3 show longitudinal cross sections in the bottom region of an ignition coil housing modified with respect to FIG. 1 as the ignition coil housing is filled coaxially.

FIG. 4 shows another modified ignition coil housing for filling with an insulating resin via a laterally premolded riser.

FIG. 5 shows a longitudinal cross section through an ignition coil housing as the ignition coil is filled with the aid of a hollow needle from the top region of the ignition coil.

### DETAILED DESCRIPTION

An ignition coil 10 for ignition systems, in particular an ignition coil in an internal combustion engine, is provided for direct contact with a spark plug 12, which is inserted in the conventional manner (not shown) in a shaft in a cylinder head of an internal combustion engine.

Ignition coil 10 configured in the form of a so-called rod-type ignition coil 11 is largely rotationally symmetric and contains in a coaxial arrangement with respect to a longitudinal axis 13 a longitudinal cylindrical core 14 made of magnetic material. Concentrically arranged around core 14 is a first winding form 17 as a primary coil form made of plastic, which may be configured as an extrusion coating of core 14 or as a separate mounting form. A primary winding 18 carrying a low voltage is applied on first winding form 17.

At a small radial distance, a second winding form 21 is arranged over a first gap 19 with respect to primary winding 18, which is provided with a secondary winding 22 carrying a high voltage.

Alternatively, secondary winding 22 may also be situated inside and primary winding 18 outside.

At a small radial distance over a second gap 23 with respect to secondary winding 22, this is followed by a housing 24 made of plastic. Outside of housing 24, alternatively within, a tube-shaped yoke element 26 is situated jacket-like as a sheet metal part for shielding the magnetic field of rod-type ignition coil 11 toward the outside.

On one side of housing 24, this is followed by a high-voltage connector 27 for conducting the ignition energy of rod-type ignition coil 11 to spark plug 12 indicated by a dashed line. A connection section 29 is situated on the other side of housing 24. An interior space 30 is formed between housing 24, high-voltage connection 27 and connection section 29.

High-voltage connection 27 comprises in particular a dome 31, a protective jacket 32, an electrode 33 and a contact spring 34. Dome 31 is a plastic part of one piece with housing 24, alternatively a plastic part separated from housing 24, in the basic shape of a sleeve and coaxially situated with respect to longitudinal axis 13, which surrounds contact spring 34 connected to a terminal stud 36 of spark plug 12 in an electrically conductive manner and a terminal pin 37 of stepped cylindrical electrode 33, which is likewise in electrical contact with contact spring 34. In an appendage 38 of dome 31 directed towards interior space 30, electrode 33 is supported in such a way that interior space 30 at this end is tightly sealed. Electrode 33 is connected in an electrically conductive manner via a contact plate 39 running into interior space 30 to one end of secondary winding 22.

Over a partial length of dome 31, stepped sleeve-shaped protective jacket 32 made of silicone rubber, directed toward spark plug 12, is attached, which surrounds an insulator 41 of spark plug 12 and seals off the contact region between spark plug 12 and rod-type ignition coil 11.

Connection section 29 comprises a primary connector 42 capable of being contacted by low voltage and, except for a region 43, in which the plug connector 45 connected to primary winding 18 is situated, is configured as an on its front side essentially sleeve-shaped, one-piece component.

Additionally, mention is made of the fact that the housing construction of ignition coil 10 described so far may be modified in multiple ways and is not limited to the specific embodiment described.

When installing rod-type ignition coil 11, among other things, core 14 and the two winding forms 17 and 21 supporting primary winding 18 and secondary winding 22 are inserted into housing 24. Following the insertion and possibly additional installation steps, interior space 30 is filled up to a level 44 with a cast resin 46. Cast resin 46, which is solid once cooled, fills up in particular gap 19 and 23 as well as the possibly existing gap between core 14 and inner winding form 17. Filling up with cast resin 46 is used to prevent voltage spark-overs between the individual components in the operation of rod-type ignition coil 11. For this purpose, the present invention provides for cast resin 46 to be preferably introduced into housing 24 in bottom region 47 of housing 24, i.e. on the side lying opposite of connection section 29. Subsequently cast resin 46 rises to the top as a so-called rising cast in the direction of connection section 29 in housing 24 such that at least winding forms 17 and 21 are surrounded across their entire length by cast resin 46.

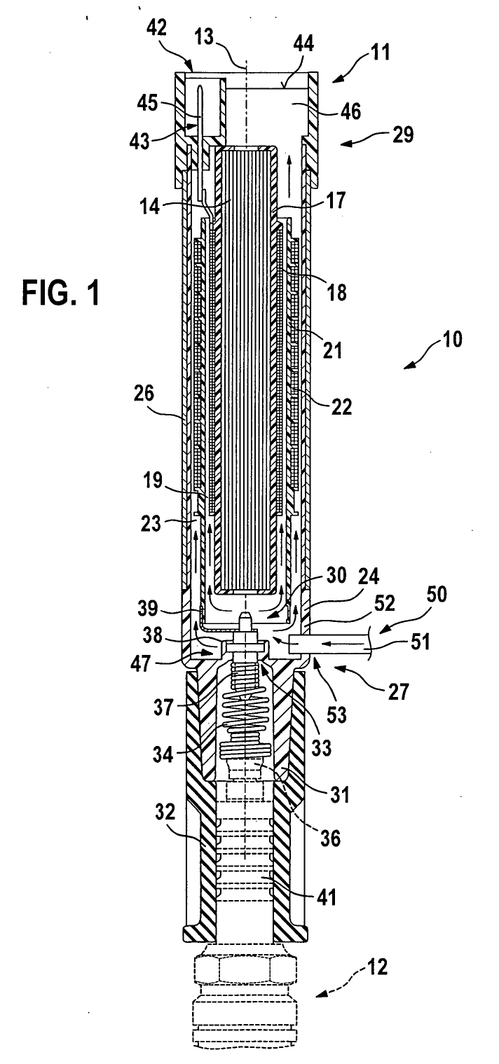

The first specific embodiment of the present invention according to FIG. 1 provides for cast resin 46 to be introduced with the aid of a feed device 50 from the side, preferably below the two winding forms 17, 21, into bottom region 47 of housing 24. For this purpose, feed device 50 has a hollow needle 51, which is capable of being inserted through wall 52 of housing 24 into bottom region 47. To achieve this, wall 52 of housing 24 is made, at least in the region of the entry point 53 of hollow needle 51 into housing 24, from a material through which hollow needle 51 is able to penetrate into housing 24, from an elastomer for example. Entry point 53 is preferably configured in such a way or hollow needle 51 has such a diameter that, after interior space 30 has been filled up and hollow needle 51 subsequently has been pulled out, the material of wall 52 will close by itself or no cast resin 46 will leak out of housing 24 due to the surface tension of cast resin 46.

Filling up interior space 30 from bottom region 47 in the direction of connection section 29 has the advantage of achieving a more homogeneous distribution of material and of preventing inclusions of foreign media or particles. The cast resin front pushes gases present in the interior of housing 24 ahead of itself and thus channels them out of housing 24, which results in improved venting. Filling occurs at overpressure, i.e. cast resin 46 issues from hollow needle 51 at overpressure. In this regard, the highest possible pressure is to be aimed at in order to make the filling time as short as possible.

In the first exemplary embodiment shown in FIG. 1, it is advantageous or necessary to fill interior space 30 from the side due to the construction of housing 24 having electrode 33 situated in longitudinal axis 13 near bottom region 47.

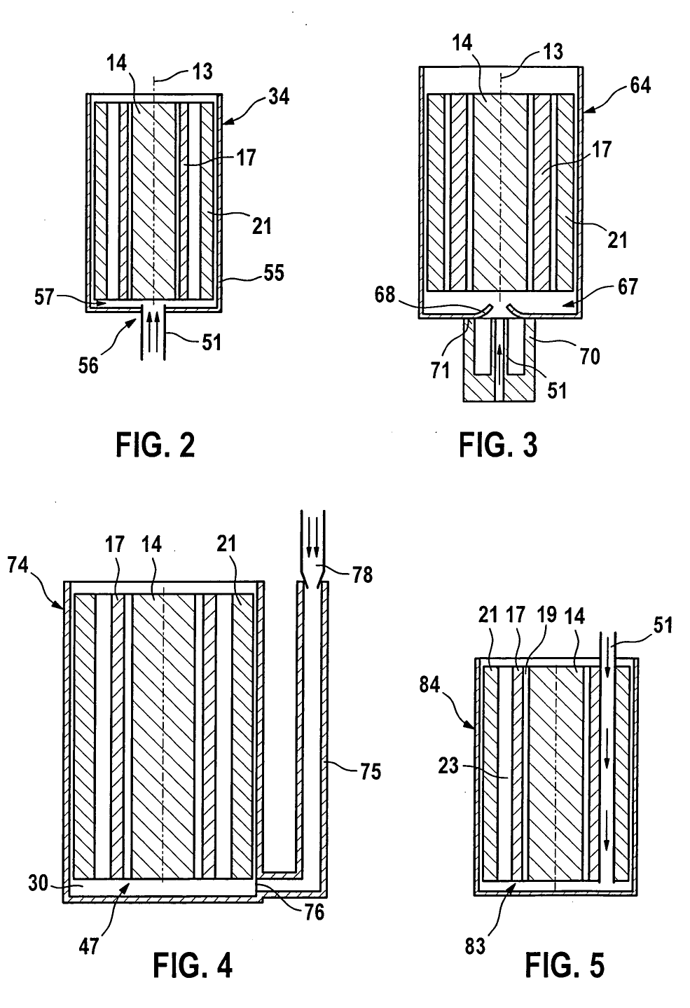

FIGS. 2 and 3 show exemplary embodiments in which the construction of housing 54 or 64 allows for it being filled coaxially with respect to longitudinal axis 13 or parallel to it from bottom region 57 or 67. Analogous to the first exemplary embodiment, in the exemplary embodiment according to FIG. 2, wall 55 of housing 54 in the region of at least the entry point 56 of hollow needle 51 is made of a material which allows for hollow needle 51 to penetrate and prevents cast resin from leaking out following the filling process. In the exemplary embodiment according to FIG. 3, by contrast, a diaphragm 68 or a pressure-relief valve is situated in bottom region 67, as it is known in particular from the food sector, e.g. in honey containers. Such a diaphragm 68 or pressure-relief valve has the characteristic of opening at a specific overpressure and thus to create a passage for a medium, in this case the cast resin. As soon as the overpressure has fallen below a structurally determined value, however, diaphragm 68 or the pressure-relief valve recloses the opening such that no medium can emerge from housing 64. In the embodiment according to FIG. 3, hollow needle 51 is situated for this purpose within a bell-like filling stub 70 whose front-side edge 71 can be brought into contact with the bottom side of housing 64 in such a way that diaphragm 68 or the pressure-relief valve is located within edge 71. To fill housing 64 it is sufficient to guide hollow needle 51 merely up to diaphragm 68 or the pressure-relief valve, that is, to dock it to the latter. It is not necessary for hollow needle 51 to penetrate into diaphragm 68 or the pressure-relief valve, so that this approach promises advantages with respect to operating time of hollow needle 51 and the nonexistent danger of damage to components located within housing 64.

The exemplary embodiment according to FIG. 4 essentially corresponds to the first exemplary embodiment such that here too housing 74 is filled up from the side. In contrast to the first exemplary embodiment, however, no hollow needle 51, but rather a so-called riser 75 is used for filling or introducing the cast resin into the bottom region 47. Riser 75 is integrally formed on housing 74 and is connected via a hole 76 in housing 74 to the interior space 30 of housing 74. Via riser 75, the cast resin is introduced, for example by a casting nozzle 78, at overpressure into interior space 30. Following the filling and curing of the cast resin, riser 75 is separated at its connecting point to housing 74.

In the exemplary embodiment according to FIG. 5, the cast resin is likewise introduced into the bottom region 83 of housing 84 with the aid of a hollow needle 51. For this purpose, hollow needle 51 is introduced into a gap extending to bottom region 83, either the gap between core 14 and inner winding form 17 or gap 19 between the two winding forms 17, 21 or gap 23 between outer winding form 21 and housing 84. Which of the gaps is suitable must be decided by considering the size of the gap and a possible danger of damaging the components when hollow needle 51 penetrates into housing 84. Possibly the (outer) diameter of hollow needle 51 must also be reduced in comparison to the exemplary embodiments described so far. It is advantageous in the last of the exemplary embodiments described that housing 84, with the exception of the accessibility of hollow needle 51 from the side of connection section 29, does not require a special configuration or any additional components.

What is claimed is:

1. A method for manufacturing an ignition coil, comprising:
during an installation in an ignition coil housing, arranging a magnetically active core, a primary coil form having a primary winding, and a secondary coil form having a secondary winding;
subsequently filling up gaps between the core, the primary coil form, and the secondary coil form in the ignition coil housing with an insulating compound that is initially a liquid; and
introducing the initially liquid insulating compound into the ignition coil housing at least partly against gravity and directly into a bottom region of the ignition coil housing.

2. The method as recited in claim 1, wherein the ignition coil includes a rod-type ignition coil.

3. The method as recited in claim 1, wherein the insulating compound is introduced into the bottom region with the aid of a feed device in the form of a hollow needle.

4. The method as recited in claim 1, wherein the insulating compound is introduced into the bottom region with the aid of a riser premolded on the ignition coil housing.

5. The method as recited in claim 4, wherein the insulating compound is introduced from the side in relation to a longitudinal axis of the ignition coil housing.

6. The method as recited in claim 3, wherein the insulating compound is introduced parallel to a longitudinal axis in relation to a longitudinal axis of the ignition coil housing.

7. The method as recited in claim 6, wherein:
the hollow needle is inserted coaxially with respect to the longitudinal axis into a gap between the core and the coil form adjacent to the core, or between the two coil forms, or between one coil form and the ignition coil housing adjacent to this coil form.

8. An ignition coil, comprising:
an ignition coil housing;
a magnetically active core situated in the ignition coil housing;
a primary coil form having a primary winding and situated in the ignition coil housing;
a secondary coil form having a secondary winding and situated in the ignition coil housing; and
an insulating compound for filling in gaps in the ignition coil housing, wherein a wall of the ignition coil housing has a passage for a feed device for the insulating compound.

9. The ignition coil as recited in claim 1, wherein the ignition coil includes a rod-type ignition coil.

10. The ignition coil as recited in claim 8, wherein the passage is configured as a selfclosing passage in the form of a diaphragm, a non-return valve, or using a selfclosing material corresponding to an elastomer.

11. The ignition coil as recited in claim 8, wherein the passage is configured as a hole that cooperates with a riser premolded in one piece on the ignition coil housing.

12. The ignition coil as recited in claim 8, wherein the passage is situated in a bottom region of the ignition coil housing.
